(19) United States
(12) Patent Application Publication
(10) Pub. No.: US 2015/0302054 A1
(43) Pub. Date: Oct. 22, 2015

(54) PROCESS FOR IDENTIFYING CONTACTS LIKELY TO BE NEEDED BASED ON USER COMMUNICATION HABITS

(71) Applicant: Dimitrios Spanos, Redwood City, CA (US)

(72) Inventor: Dimitrios Spanos, Redwood City, CA (US)

(21) Appl. No.: 14/693,794

(22) Filed: Apr. 22, 2015

Related U.S. Application Data
(60) Provisional application No. 61/982,791, filed on Apr. 22, 2014.

(51) Int. Cl. G06F 17/30; H04L 29/12; H04L 29/08

(52) U.S. Cl. CPC G06F 17/30424; H04L 67/22; H04L 61/609

(57) ABSTRACT

A dynamic contact list based on a user's communication habits is disclosed. Some embodiments include a method for tracking a user's communication habits and dynamically providing, from a first set of contacts, a reduced contact list with a second set of contacts that the user is likely to need in a given situation. In some embodiments, the method is implemented as software that tracks the communication actions of the user and then processes that data taking a number of variables into account such as time, location, recurring calls, calendar events, and other variables, to try to understand the user's habits. Upon request, the software then comes up with a short list of possible candidates with which the user will most probably communicate at a given time highlighting a specific communication method in each situation.

### CLAIM OF BENEFIT TO PRIOR APPLICATION

This application claims benefit to U.S. Provisional Patent Application 61/982,791, entitled “PROCESS FOR TRACKING A USER'S COMMUNICATION HABITS AND DYNAMICALLY PROVIDING A REDUCED LIST OF CONTACTS THE USER IS LIKELY TO NEED,” filed Apr. 22, 2014. The U.S. Provisional Patent Application 61/982,791 is incorporated herein by reference.

### BACKGROUND

Embodiments of the invention described in this specification relate generally to contact list management and organization processes, and more particularly, to a process for identifying likely contacts of a contact list based on user communication habits.

Electronic computing devices are typically capable of communication with other devices. Many computing device programs, therefore, include ways to manage and organize contacts. For example, an address book is typically included on a computing device, such as a mobile computing and/or communication device (hereafter referred to “computing device”, “mobile device”, “mobile computing device”, etc.), so that a user of the computing device can include one or more contacts so that the user is able to communicate with contacts within a network when there's a need to communicate. Unless the target contact is part of a list of preselected contacts (sometimes known as favorites) or the recent incoming/outgoing list, the user has to search for it and then select the method of communication.

This is not time efficient especially for people who have big address books and make a lot of calls. It takes time to go through the lists and then type the name, locate the right element from the contact and initiate.

The interfaces offered by the address book system are meant to give the user access to either the whole database of contacts or to selected parts of it that are either predefined by the user (favorites list) or based on the recent voice calls. Users tend to favor picking the contact from the shorter lists instead of having to type part of the its name, so they often look the contact up in those lists first but then end up searching by name which is not time efficient.

Therefore, what is needed is a way to track the communication activities of a user and to thereby understand the user's communication habits, in order to come up with a short contact list, at the time of any such request for a list, where the short list includes possible candidates with which the user will most probably communicate at a given time highlighting a specific communication method for each one too.

### BRIEF SUMMARY

Some embodiments of the invention include novel methods for providing a set of likely-needed contacts to a user of a computing device. In some embodiments, a basic usage cycle method identifies the set of likely-needed contacts based on the user's communication habits and provides the identified set of likely-needed contacts to the user for selection of a contact. In some embodiments, a prediction engine process tracks a user's communication habits and dynamically provides, from a first set of contacts, a reduced contact list comprising a second set of contacts that the user is likely to need in a given situation.

Some embodiments include a software-implemented method which tracks the communication actions of the user and then processes that data taking a number of variables into account such as time, location, recurring calls, calendar events among others to try to understand the user's habits. Upon request, it then comes up with a short list of possible candidates with which the user will most probably communicate at a given time highlighting a specific communication method for each one too.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments.

FIG. 1 conceptually illustrates a basic usage cycle process, in some embodiments, that provides a set of likely-needed contacts to a user of a computing device.

FIG. 2 conceptually illustrates a process in some embodiments for determining a set of location parameters associated with the location element of the basic usage cycle process of FIG. 1.

FIG. 3 conceptually illustrates a prediction engine process for identifying contacts likely to be needed based on user communication habits in some embodiments.

FIG. 4 conceptually illustrates a set of actions in some embodiments from which the activity of the prediction engine process of FIG. 3 can be determined.

FIG. 5 conceptually illustrates a process in some embodiments for determining the time element of the basic usage cycle process of FIG. 1.

FIG. 6 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include novel methods for providing a set of likely-needed contacts to a user of a computing device. In some embodiments, a basic usage cycle method identifies the set of likely-needed contacts based on the user's communication habits and provides the identified set of likely-needed contacts to the user for selection of a contact. In some embodiments, a prediction engine process tracks a user's communication habits and dynamically provides, from a first set of contacts, a reduced contact list comprising a second set of contacts that the user is likely to need in a given situation.

In this specification, there are several descriptions of methods and processes that are implemented as software applications and run on computing devices to perform the steps of the methods and/or processes. However, it should be noted that for the purposes of the embodiments described in this specification, the word “method” is used interchangeably with the word “process”. Methods for providing a set of likely-needed contacts to a user of a computing device are described, therefore, by reference to several example processes that conceptually illustrate process steps for identifying contacts a user is likely to need in a given situation and providing the identified contacts to the user for selection of a contact.

As stated above, many computing device programs include programs, apps, and/or program modules to manage and organize contacts for communication, because computing devices are typically capable of communication with other computing devices. In particular, an address book is typically included on a computing device so that a user of the computing device can include one or more contacts so that the user is able to communicate with contacts within his or her network when there is a need to communicate. For example, a user of a mobile computing device may wish to communicate with a specific target contact, but unless the target contact is part of a list of preselected contacts (sometimes known as favorites) or the recent incoming/outgoing list, the user normally has to search for the target contact and then select the method of communication. This is not time efficient especially for people who have big address books and make a lot of calls. It takes time to go through the lists and then type the name, locate the right element from the contact and initiate. Embodiments of the invention described in this specification solve such problems by a software-implemented process that utilizes a number of algorithms along with machine learning and tries to predict the contact which the user intends to communicate with as well as the method of communication and presents the user with a short list of possible candidates so the user doesn't have to look elsewhere or search by name.

The embodiments described in this specification differ from and improve upon currently existing options. In particular, previously, users had to rely on the static lists to find the contact that they were looking for. In any case the last step is selecting the appropriate communication method by picking the right element from the contact's data. People have different needs however throughout the day that those short lists cannot satisfy, unless the user searches the whole address book. This software-based process fills that void. In addition, these embodiments improve upon the currently existing options because the above options cannot quickly help with future communications because the interfaces are either static or limited to a specific time range, unless the target contact has been pre-selected by the user and put in a short list, or it is part of the recent incoming/outgoing list. Their purpose is to highlight specific contacts (favorites list) for quick access or show the most recent communications in case user needs to call back. However user needs vary by a number of different factors.

Some embodiments include a software-implemented method which tracks the communication actions of the user and then processes that data taking a number of variables into account such as time, location, recurring calls, calendar events among others to try to understand the user's habits. Upon request, it then comes up with a short list of possible candidates with which the user will most probably communicate at a given time highlighting a specific communication method for each one too.

The software can also work as a component or a standalone application in any device as long as the address book data is available and user uses that device, component or application respectively to communicate with contacts of his network. Hence it can act as a standalone mobile application by itself in a mobile device, or as a software component of its operating system with the purpose of improving the user's dialing experience. It can serve the same purpose as an application or a software component of another application in a desktop computer. It can also act as a software component and part of an information network that revolves around personal connections such as social networking software, by identifying the user's interests and showing him relevant content from select users of his network.

Several more detailed embodiments are described in the sections below. Section I conceptually describes a basic usage cycle to provide a set of likely-needed contacts to a user of a computing device when triggered by user input to access a favorites list of contacts. Section II provides examples of specific usage cycle processes and a prediction engine process performed to identify the set of likely-needed contacts. Section III describes examples of software implementations of the processes. Section IV describes an electronic system that implements one or more of the micro-compression processes.

### I. Basic Usage Cycle to Provide a Set of Likely-Needed Contacts

This section details operations of a basic usage cycle process that is performed by the software. In some embodiments, a basic usage cycle provides an overall frame of reference to explore detailed processes performed by the software to provide a set of likely-needed contacts to a user of a computing device on which the software is running.

Initially, the software replicates the user's address book database. If the user uses or has granted access to external informational networks such as social networks, media networks, and/or other such services, the software communicates with those networks (e.g., by one or move available interfaces, such as a programmable interface or API) and collects additional information to enrich the address book with metadata about each contact and use that metadata to make better predictions. This user information may include name, profile pictures, work-related information such as the company and the title, birth date, events or groups associated with the target user, location related information such as the current city of residence or area of activity among others.

Every time a user chooses to communicate with a contact from his address book in some way, the software records that transaction and its details which include the date, time, location and the method of communication and links it to the contact. The method of communication can be a call, a text message, launching a social profile, directions to one's address, an email among others.

In some embodiments, one or more of the methods of communication may have different weighting from one or more of the other methods. The weights are variables defined by the user activity preferences and change over time. The software uses the above data and tries to identify the user's habits. All the processing takes place in the computational unit of the software.

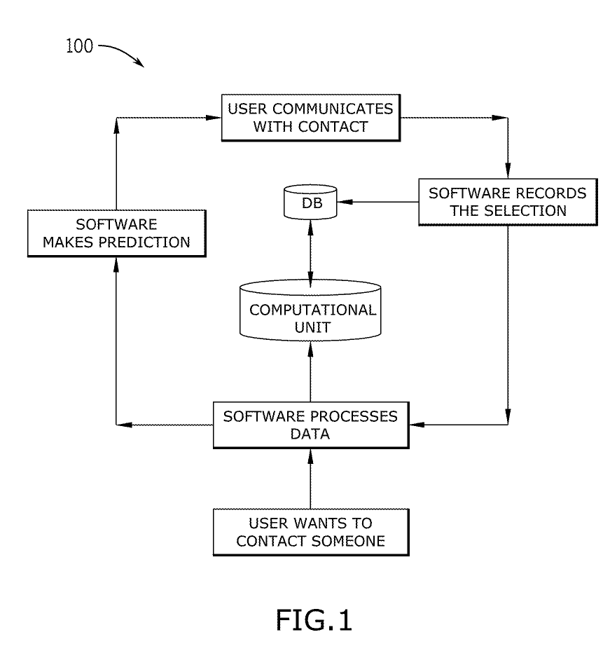

The usage cycle described above is described next by way of example to FIG. 1, which conceptually illustrates a basic usage cycle process 100 that provides a set of likely-needed contacts to a user of a computing device. In some embodiments, the basic usage cycle process 100 is performed by the software when running on a processing unit of the user's computing device (e.g., a mobile computing device, such as a smartphone, etc.). As shown in this figure, the basic usage cycle is a continuous cycle that is triggered by the user's request to access a contact list that includes these predictions. In some cases, and for the purposes of this example, the contact list with the predictions is called “the Favorites List” and includes contacts with a specific method of communication preselected that is found the most appropriate by the software at the time.

First, the process 100 retrieves a set of activity data from a database. The process 100 applies initial weights to the retrieves data. The initial weights are basic weights related to fundamental aspects of a contact list, such as an initial weight based on a time element and another initial weight based on a location element. Other initial weights, such as those for frequency of contact, communication pattern-based elements, and other contact-related metadata may be applied by the process 100. When implemented as a software application, the software simply pulls the activity data from the database and applies the initial weights by way of a computational module/unit of the software application.

The process 100 comprehensively considers all aspects of contact management and organization when determining the most likely-to-be-needed contacts for a user in a given situation, place, and time. In particular, every activity snapshot as well as every contact is assessed with regard to different elements and then a probability value is calculated. In some embodiments, the process 100 performs redundancy processing of all contextual aspects of the contacts and all circumstances of the user, to ensure that the final list of predicted contacts includes such contacts that are highly likely to be needed by the user under the given set of user circumstances. Thus, the basic usage cycle process 100 selects the contacts and activity snapshots with the highest probability values to include in the final list, which is then presented to the user in the form of the Favorites List.

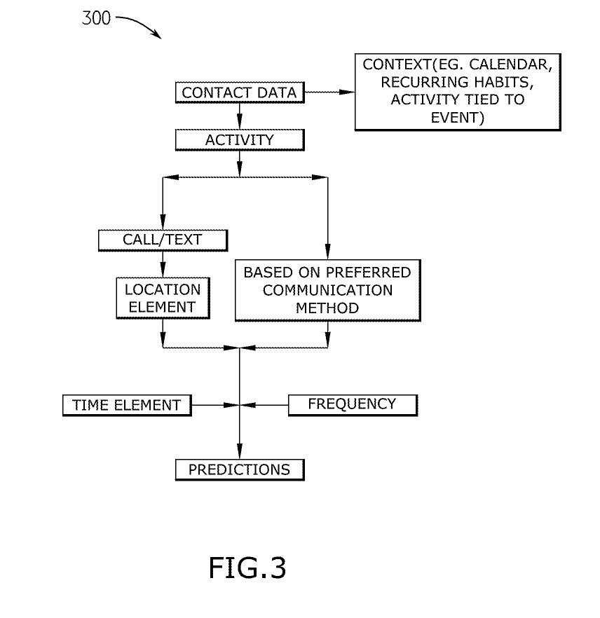

The process 100 then tracks a user selection from the final list (or tracks an absence of a selection, if the user opted to find a contact in another way). The process 100 then stores the tracked selection/absence of selection in the database. The process 100 may then update weighting values for one or more of the weights described above. The various formulas and weights described in some steps of the basic usage cycle process 100 are described in more detail by reference to FIG. 3, below, which illustrates a prediction engine process. Then the cycle repeats (according to user activation/triggering of the need for a contact).

When the process 100 is implemented by software and the software is performing the basic usage cycle process 100 on the user's computing device, the software will reprocess the data after initial processing of the data by the software (e.g., pulling the activity data from the database and applying the initial weighting factors to the time element, the location element, the frequency, the communication patterns, and the other contact metadata retrieved by the computational module/unit of the software). In addition to reprocessing the initial data, the software will use metadata from one or more previous cycles to come up with the final list of predictions of contacts likely to be needed by the user. This final list is then presented to the user (e.g., Favorites List displayed on a display screen of the user's computing device).

Next, the software receives a selection from the Favorites List (e.g., the user selected one of the contacts determined to be a likely needed contact). The software tracks the user's choice or absence of choice (e.g., the user resorts to another using a different resource to find a contact, instead of using the favorites list).

When the software tracks the user's choices, the software can assess its accuracy and tweak the prediction process as needed. In doing so, the software may change some of the values of the weights used in the calculations. Hence, both the activity itself is tracked and stored in the database as well as various other metadata that will help the system itself recalibrate its own formulas based on the user habits. In this way, the software trains itself to identify contacts that are likely to be needed by the user in a given situation.

Recent activity may also be passed directly to the following decision round of the basic usage cycle. For example, a recent activity can be stored in a separate pool and can be passed to the next cycle if the next activity is closely related to the particular recent activity in terms of timing and other metadata. Metadata for the last direct feed of the cycle to the next round may also include the number of successful selections of the user based on that process and other available information that may be available, such as duration of call, location and signal strength at a given time, and/or last time of communication.

The individual steps of the process 100, and operations of software that implements the process 100, provide a general overview of the basic usage cycle of the process when a user is engaged in accessing the Favorites List. Detailed operations of this basic usage cycle are described in the next section.

### II. Specific Usage Cycle Process Operations

In some embodiments, the user's location is taken into account first. To take the user's location into account, certain location information needs to be determined. For example, a software application may include a set of location parameters which stores various location information of the user and that allows location to be taken into account.

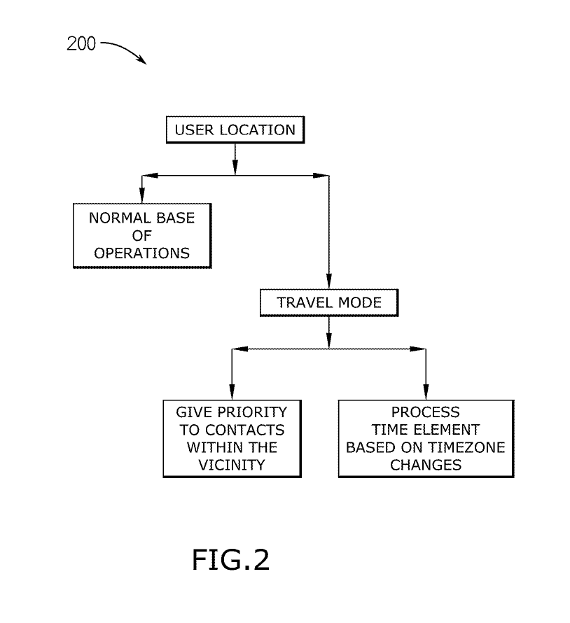

By way of example, FIG. 2 conceptually illustrates a process 200 in some embodiments for determining a set of location parameters associated with the location element (e.g., the user's current location) of the basic usage cycle process 100 of FIG. 1. The user's current location can either be (i) the normal base of operations for the user, which is the greater vicinity within which the user uses the application most of the time or (ii) outside the user's normal base of operations. If the user is outside his base, the process 200 considers the user to be in “Travel Mode”. When the algorithm is ranking communication by computing time proximity, if the process 200 determines that the user is in “Travel Mode”, then the process 200 will give priority to contacts in the vicinity of the user and will take into account the timezone difference. As a location parameter, the process 200 considers the time difference factor by taking into account the time difference between the user's current location, and the normal base of operations, the user's communication habits at the local time of the normal base of operations' location and the current time zone of otherwise possible candidates, especially when the communication method is voice or texting. Based on the communication habits of the user and past trends, the process 200 of some embodiments attempts to identify which of the contacts outside the user's current timezone are “local” contacts (i.e., locally-tied to the user's normal base of operations) and which of the contacts outside the user's current timezone are not “local” contacts (e.g., contacts from a location that is distant from both the user's normal base of operations and the user's current timezone location).

In order to create the predictions at a given time, the software completes several operations which are generally outlined next by way of reference to FIG. 3, which conceptually illustrates a prediction engine process 300 for identifying contacts likely to be needed based on user communication habits. The prediction engine process 300 outlines several of the very basic steps and operations (e.g., algorithmic operations, determinations, computations, and/or calculations) that are performed to come up with a list of predictions of contacts likely to be needed in a given situation, time, location, etc. As shown in this figure, contextual data, such as calendar events or specific recurring habits related to a specific day and time-wise proximate to a given time, are provided enhanced weight. Although such contextual data are factored into the overall weighting process for all the contacts, the contextual data are only temporarily stored in a separate pool until final selection of contacts takes place.

After that, all activity data is processed and grouped by contact and the preferred method of communication is established for each one of the contacts. Communications which are mainly based on voice or texting have increased or reduced weights based on their location, which is described in greater detail above, by reference to FIG. 2. Such communications end up having increased or decreased weights depending on their assumed relationship to the user (e.g., local contacts or distant contacts, or distant contacts in which the user communicates with them regardless of where the user is, in which case the software takes the timezone difference into account and considers the relative weighting in comparison with weightings of those in the rest of the pool, etc.).

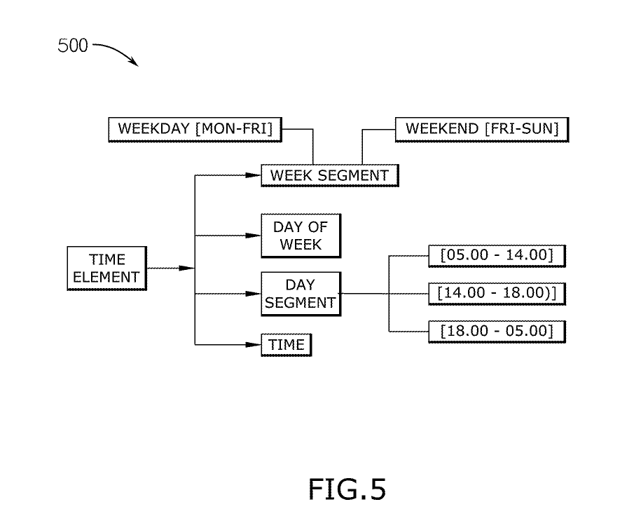

Then the prediction engine process 300 establishes frequency for every activity, takes location into account, as well as several communication habits (such as recurring events, surprise calls, distribution of communication methods, communications based on the time element, which is described in further detail by reference to FIG. 5, below), sorts the results based on their probability, and creates the list with the best candidates of contacts likely to be needed by the user.

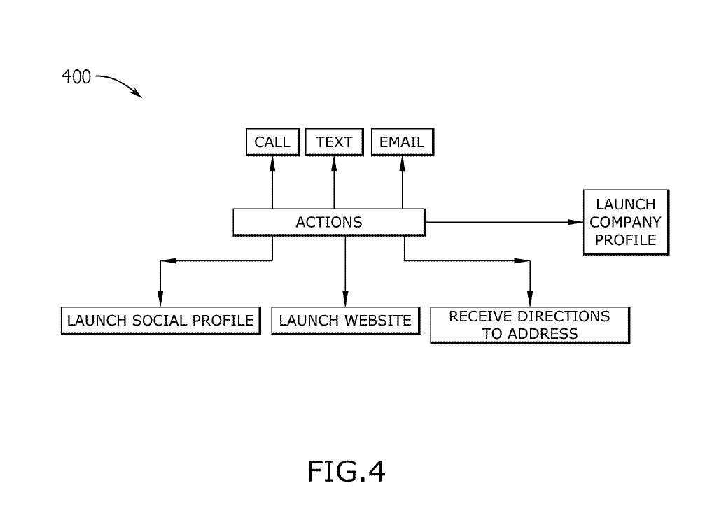

In some embodiments, a part of the list is dedicated to contacts who the user will most likely communicate specifically by voice, text, or email. In these embodiments, the rest of the entries are based on the communication preferences of the user. By way of example, FIG. 4 conceptually illustrates a set of actions 400 in some embodiments from which the activity of the prediction engine process 300 of FIG. 3 can be determined. As shown in this figure, the set of actions 400 includes a set of communication methods that a user may utilize to communicate with a contact. In this example, the set of communication methods include call, text, email, launch company profile, launch social profile, launch website, and receive directions to address.

In some embodiments, the portions are dynamic and change according to user activity. The following formula provides one way in which the portions are continuously adjusted based on the user's activity.

L(x)=w_{ct}*x+wₑ*x+wᵣ*x

w_{c}+wₑ+wᵣ=1

w_{c},wₑ,wᵣε[0,1]

L(x) is the function that represents the synthesis of the Favorites List.

w_{ct} is the weight applied to entries of the Favorites List that involve either voice calling or texting.

wₑ is the weight applied to entries of the Favorites List that involve emailing.

wᵣ is the weight applied to entries of the Favorites List that are not associated to a specific communication method, therefore they can be any type of communication.

x is the number of Favorites List's entries.

Based on user activity, the software tries to pick up the user's habits and can consolidate parts of the list that are dedicated to specific activities, or create new parts dedicated to other communication actions such as launching a social profile.

Contacts whose primary method of communication is voice or texting are filtered by location and proximity. Location is determined by either the address(es) of the contact, or GPS provided by previous communication activity with that contact.

As described above, by reference to FIG. 3, the prediction engine process 300 determines a time element. To take the time element into account, therefore, the time element needs to be calculated. For example, the software may consider contacts and communication in the context of the time element. All contacts and communication methods are then filtered through time and frequency.

By way of example, FIG. 5 conceptually illustrates a process 500 in some embodiments for determining the time element of the prediction engine process 300 described above, by reference to FIG. 3. Frequency of communication by itself contributes to the probability value. In order from lowest to highest weight, the software starts by processing historical activities of the same week segment. For instance, the possible values may include weekday (Monday to Friday) and weekend (Friday to Sunday). Activities occurring on the same day are given priority. Then the software narrows down the scope prioritizing activities on the same day segment and lastly close to the given time.

freq(x)=wₐ*x

freq(x) is the function of activity.

wₐ is the weight applied to the specific activity. Different activities may or may not have different weights.

x is the sum of activities recorded in the snapshot for a specific contact.

P(x)=freq(x)+freq(x)*w₁+freq(x)*w₂+freq(x)*w₃+freq(x)*w₄(t−tₐ)

P(x) is the probability value for a contact.

w₁ is the weight applied to activities in the same week segment.

w₂ is the weight applied to activities in the same day of week.

w₃ is the weight applied to activities in the same day segment.

w₄(t−tₐ) is the function that computes the weight applied to activities based on the time proximity where both t, tₐε[0, 24].

t is the current hour of the day with range as described above.

tₐ is the hour of the historical activity being processed.

The software may choose to employ one, all, or a combination of the parts of the time element's full equation P(x) depending on the available data and the complexity of the user's habits.

In some embodiments, after the software goes through the above steps, it ranks the contacts based on the probability value from highest to lowest and presents a select number of contacts from the top of the list as predictions.

The weights w₁, w₂, w₃, w₄, wₐ, w_{ct}, wₑ, and wᵣ are based on user activity and trained by the predictions' success. When the software presents the user with a list of predictions, it tracks down the user's selection. The software records the user's chose communication action towards the target contact to be later used in future predictions as historical data. It also records statistics such as the chosen entry's position in the list given the time and other contextual parameters, to assess its own success in predicting results and adjust the variables mentioned above.

### III. Software Implementation of Processes

When the process for tracking communication habits and dynamically providing a set of likely contacts is implemented as software, the following elements may be included. This list of possible constituent elements is intended to be exemplary only and it is not intended that this list be used to limit embodiments of the invention of the present application to just these elements. Persons having ordinary skill in the art relevant to the present disclosure may understand there to be equivalent elements that may be substituted within the present disclosure without changing the essential function or operation of the embodiments described in this disclosure.

1. A computing device with audio-input access, audio output capability, a display and a keyboard or other input device (such as a touch screen or other manually manipulable interface for controlling on-screen activity), and a processing unit on which the software runs while performing the operations of the process. The computing device may be a stationary computing device, such as a desktop computer, or a mobile computing device, such as a smartphone. The mobile computing device may also include a GPS tracking controller.

2. An address book or contact list capable of receiving information associated with the user's contacts and of persistently storing such contact information.

3. A database or application capable of storing calendar events.

4. A computer-readable medium for storing the software.

5. External information networks.

6. A computational unit that is either local and within the software's virtual machine or one that resides in an external server and is accessible via an application programmable interface (API).

The various elements of some embodiments may be related in the following exemplary fashion. It is not intended to limit the scope or nature of the relationships between the various elements and the following examples are presented as illustrative examples only. The mobile device (1) is where all the interaction happens. It is the device which the user uses to communicate with other contacts. User fills the address book (2) with his own contacts. The address book may be part of the device's (1) core pre-installed operating system or may reside in a third party application. User may also create and store calendar events (3) either through an interface provided by the device's (1) core operating system or a third party application. The software (4) is installed in the mobile device (1) by the user and interacts with the address book (2), the calendar database (3) and the GPS system (1) of the device. The software also connects with the external information networks (5) to get additional information on the user's contacts and uses the computational unit (6) to process data and present the user with a list of predictions at a given time.

Some embodiments work for a user who has a mobile computing device that is used for communication and with the characteristics described above (i.e., contact list, calendar, etc.). The first step is to populate the device's address book database with his contacts. Alternatively, the user can install and use a third party application for the same purpose. Having an address book database filled with contacts is needed in some embodiments. The user may also use the device's calendar database or a third party application to log events in the calendar. The user may then install the software in the device. Upon installing and launching the software for the first time, the software will request access to the address book database, the calendar database, and, if available, the GPS component of the device. If the user does not grant access to an address book database, the software will keep requesting access or may fail to operate. In some embodiments, the software can get contact data from an outside source or directly from the user (e.g., the user uploads or enters the contact information). In some embodiments, no source of contact information may render the software inoperable. If the user makes use of external information networks such as social networking applications (e.g., Facebook, LinkedIn, Twitter, etc.), he may grant access to the software so that it can enrich its information about the contact with more metadata. The software may request access to calendar databases and the GPS component of the device for the same reason. If the user does not grant permission to communicate with those then the software will still perform using the available data. If the computational unit resides in an external server and is not running within the software's runtime context (or virtual machine VM), the software will communicate with it via a set of APIs (Application Programmable Interfaces) to process the data and get recommendations, otherwise the application logic of the software itself will handle the processing and the recommendations.

To make a process for tracking user communication habits and dynamically provided a likely set of needed contacts, a person writes software code to implement software that is able to complete the steps and operations described above and provide the user with the useful tool described here-above. In standard practice, the calendar database, the GPS component and the external information networks may not be needed, but are optionally provided in some embodiments. If these are present then the database formed by the software has additional metadata and can form predictions much more effectively. Alternative scenarios are also presented in the section that describes how the software works. The software is continuously trained by user's choices and input. Therefore all the weights in the software are adjustable and depend on the algorithm success in predicting the user's choices. The way through which the software measures its success rate is by tracking the user's choice (e.g., the slot he selects or not) in the Favorites List after the contacts are presented. Depending on the user's habits the software may employ also more or less sections dedicated to one or more specific ways of communication (e.g., by launching a social profile of a contact such as Facebook, Twitter, or LinkedIn, or by having a section about launching directions to contacts' addresses) as also described above.

To use the process of some embodiments, a user may operate software that implements the process. For example, the user may install the software on a computing device (e.g., the user's smartphone) first and grant access to address book data, so the software can create or replicate a database. The user may then grant access to the calendar database, (optionally) the GPS component (if used or available), and the external information networks. The user communicates with the target contacts via the software which in turn records the activities and is trained on the user's habits. In order to present the user with predictions, the software needs to have at least one activity recorded, so the user may need to have already communicated at least one time with a contact of his network. Upon each communication, the system processes the historical activity's data to improve both the process and the results of the prediction when the user requests it. After the first communication takes place, the user may request (e.g., by making a selection from a menu or tool provided by the software) to make predictions at any given time which, in some embodiments, are formed based on the user's activity up until the moment of the request.

Additionally, in some embodiments the software can produce an adjustable favorites list with one or more contacts that are available for the user to communicate with at any given time. The basic principles of the algorithm can be used to create algorithms which predict the user's behavior with broader scope based on the user's activity. Practically any process that aims to identify and predict the user's habits falls into that category. A few practical examples are: (i) news feeds, (ii) advertisement networks, (iii) news aggregators, (iv) contacts in a (social) network that a user would prefer to see, (v) places to visit or check-in, etc. Although like most prediction algorithms the software can have a broader scope based on adjustments, this algorithm is especially suited to predict user choices with different characteristics that are also tied to time and/or location.

In some embodiments, the software can also work as a component of another software application or as a standalone application in any computing device used by the user to communicate with contacts of the user's network, as long as the address book data is available. Hence it can act as a standalone mobile application by itself in a mobile device, or as a software component of its operating system with the purpose of improving the user's dialing experience. It can serve the same purpose as an application or a software component of another application in a desktop computer. It can also act as a software component and part of an information network that revolves around personal connections such as social networking software, by identifying the user's interests and showing him relevant content from select users of his network.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

### IV. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

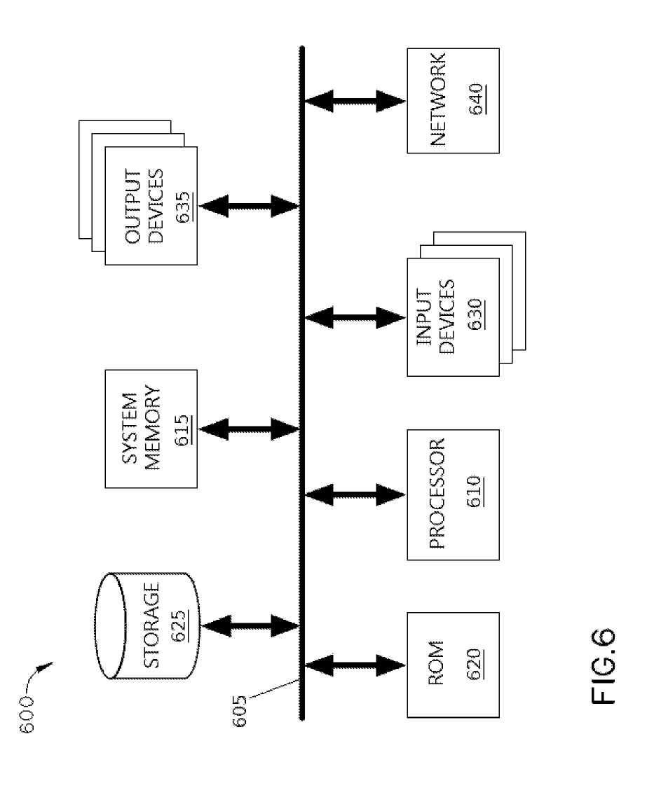

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing or cursor control devices. The output devices 635 display images generated by the electronic system 600. The output devices 635 include printers and display devices, such as cathode ray tubes (CRT) or liquid crystal displays (LCD). Some embodiments include a touchscreen that functions as both an input and output device.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an Intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by sets of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-5 conceptually illustrate processes. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device provides a reduced list of contacts that a user is likely to need in a given situation for a communication to one of the contacts, the program comprising sets of instructions for:
tracking communication actions of the user that are performed on the computing device and are related to communication with any contact in a first set of contacts;
determining a communication context for each communication action, said communication context related to one or more variables in a set of communication variables comprising time, location, recurring calls, and calendar events;
identifying the user's communication habits based on the tracked communication actions and the communication context of each communication action;
receiving a request for a contact list that the user can use for a current communication action; and
providing a second set of contacts comprising possible candidate contacts with which the user will likely communicate for the current communication action, wherein the second set of contacts is a reduced set of contacts from the first set of contacts.

2. The non-transitory computer readable medium of claim 1, wherein the location communication variable comprises one of a normal base of operations and a travel mode.

3. The non-transitory computer readable medium of claim 2, wherein the travel mode location communication variable prioritizes contacts within a travel location of the user outside the normal base of operations and reviews a time element based on any timezone difference between the travel location and the normal base of operations.

4. The non-transitory computer readable medium of claim 1, wherein the time communication variable comprises one of a weekday and a weekend.

5. The non-transitory computer readable medium of claim 1, wherein the calendar events communication variable is based on a set of calendar dates that are proximate to a current date, wherein the program further comprises a set of instructions for retrieving, from a calendar database, any stored calendar event that is scheduled within the set of calendar dates that are proximate to the current date.

6. A non-transitory computer readable medium storing a program which when executed by at least one processing unit of a computing device provides a set of likely-needed contacts to a user of the computing device, the program comprising sets of instructions for:
receiving a request to access a contact list comprising a set of contacts;
identifying a set of situational data associated with the user;
weighting the identified situational data;
retrieving a set of tracked communication habit data associated with communication habits of the user;
weighting the retrieved set of tracked communication habit data;
identifying a set of likely-needed contacts based on the weighted situational data and the weighted tracked communication habit data; and
providing the identified set of likely-needed contacts.

7. The non-transitory computer readable medium of claim 6, wherein the set of instructions for providing the identified set of likely-needed contacts comprises a set of instructions for displaying the identified set of likely-needed contacts on a display screen of the computing device.

8. The non-transitory computer readable medium of claim 6, wherein the computing device is a mobile computing and communications device.

9. The non-transitory computer readable medium of claim 6, wherein the program further comprises sets of instructions for:
receiving a selection of a particular contact in the identified set of likely-needed contacts;
tracking the selection of the particular contact; and
associating the tracked selection of the particular contact with the situation data and the communication habit data.

10. The non-transitory computer readable medium of claim 9, wherein the program further comprises sets of instructions for:
re-weighting the weighted situational data based on the tracked selection of the particular contact; and
re-weighting the set of tracked communication habit data based on the tracked selection of the particular contact.
